(19) United States
(12) Patent Application Publication
(10) Pub. No.: US 2004/0250362 A1
(43) Pub. Date: Dec. 16, 2004

(54) Electric fruit and vegetable surface cleaner/remover

(75) Inventor: David Andrew Wright, Hong kong (HK)

Correspondence Address: LEYDIG VOIT & MAYER, LTD, 700 THIRTEENTH ST. NW, SUITE 300, WASHINGTON, DC, 20005-3960, US

(73) Assignee: Ascot Pacific Limited, Tsimshatsui (HK)

(21) Appl. No.: 10/460,399

(22) Filed: Jun. 13, 2003

(51) Int. Cl. A23N 12/00; A47J 17/00

(52) U.S. Cl. 15/3.1; 15/23; 99/584

(57) ABSTRACT

A hand-held fruit and vegetable surface cleaner/remover (10) includes a handle (11), a motor (14) housed within the handle, an output shaft (15) extending from the motor, and a surface cleaning or removing utensil (20) attached to the output shaft and surrounding a portion of the output shaft.

### BACKGROUND OF THE INVENTION

The present invention relates to an electric fruit and vegetable surface cleaner/remover. More particularly, though not exclusively, the invention relates to a waterproof, hand-held, battery-operated fruit and vegetable surface cleaner/remover having a motor driven rotary cleaning utensil protected by a shroud.

When preparing vegetables for cooking or vegetables for eating, it is desirable to wash them first. When cleaning potatoes for example, it is common to immerse the potatoes in water and scrub them by hand, or with a brush or scourer. This can be a time-consuming, tiresome task.

Apples for example ought to be cleaned prior to consumption. This is because they are coated with a waxy substance to improve their appearance for sale. As much as possible of this waxy substance should be removed prior to eating the apple. Most people give apples a cursory handwashing with water and this is usually insufficient to remove the waxy coating.

### OBJECTS OF THE INVENTION

It is an object of the present invention to overcome or substantially ameliorate at least one of the above disadvantages and/or more generally to provide a hand-held fruit and vegetable surface cleaner/remover.

It is a further object of the present invention to provide a hand-held fruit and vegetable surface cleaner/remover that can be used on wet fruit and vegetables.

It is still a further object of the present invention to provide a hand-held fruit and vegetable surface cleaner/remover having a rotatably driven utensil and a shroud adjacent to the utensil to intercept any debris that might be thrown off by the utensil in a direction toward a person using the device.

### DISCLOSURE OF THE INVENTION

There is disclosed herein a hand-held fruit and vegetable surface cleaner/remover comprising:

a housing including a handle,

a motor housed within the housing,

an output shaft extending from the motor, and

a cleaning or surface-removal utensil attached to the output shaft and surrounding a portion of the output shaft that is within the housing.

Preferably said portion of the output shaft is located within a projection of the housing.

Preferably the projection includes one or a pair of bearings supporting the output shaft.

Preferably an end portion of the projection is provided with a seal that engages with the output shaft.

Preferably there is mounted on the output shaft a connector onto which the utensil is mounted.

Preferably a shroud is attached to the handle and extends alongside the utensil.

Preferably the handle houses a battery or batteries.

Alternatively, the device can run on mains power.

Preferably the shroud is light-transmissive.

More preferably, the shroud is transparent.

Preferably the battery or batteries are rechargeable by means external to the handle.

Alternatively, the batteries can be non-rechargeable.

### BRIEF DESCRIPTION OF THE DRAWINGS

Preferred embodiments of the present invention will now be described by way of example with reference to the accompanying drawings, wherein:

FIG. 1 is a schematic cross-sectional elevational view of a fruit and vegetable surface cleaner/remover, and FIGS. 2 to 10 are schematic elevational views of alternative cleaning or surface removal utensils for attachment to the fruit and vegetable surface cleaner/remover of FIG. 1.

### DESCRIPTION Of THE PREFERRED EMBODIMENT

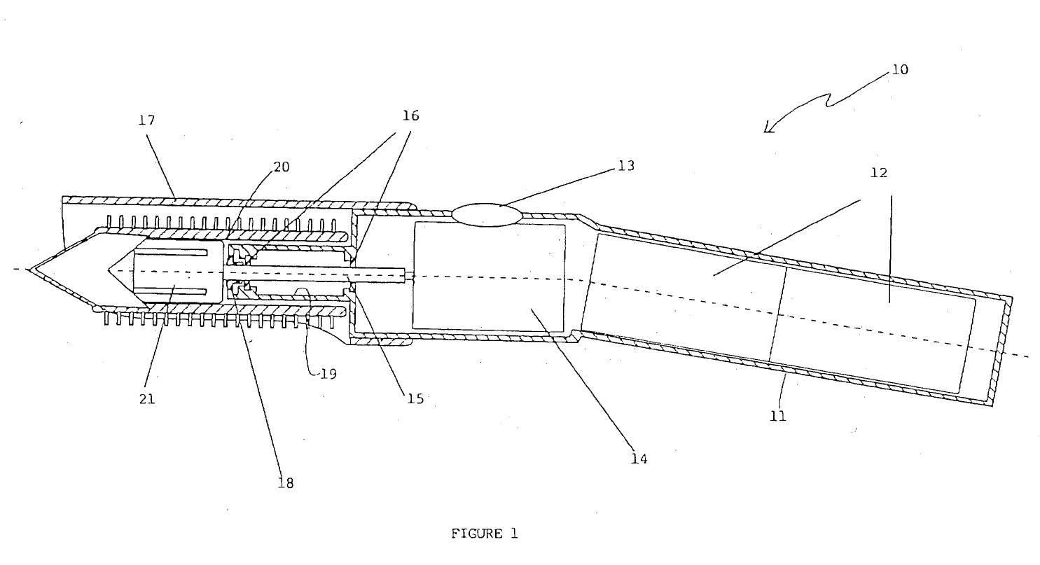

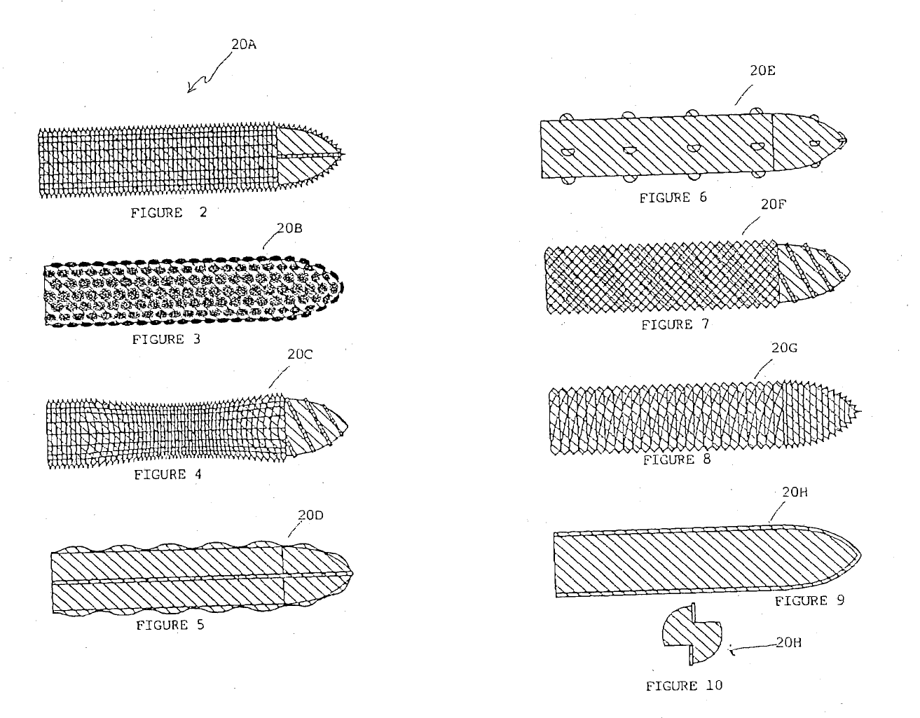

In FIG. 1 of the accompanying drawings there is schematically depicted a fruit and vegetable surface cleaner or remover 10 herein after referred to simply as device 10. Device 10 includes a handle 11 housing a pair of batteries 12 and an electric motor 14 which receives power from the batteries 12 via a switch 13. Handle 11 is typically formed of moulded plastics material.

An extension 19 which is typically integrally formed with the handle 11 projects from the front of the handle. At proximal and distal end portions of the extension 19 there are internal bearings 16 supporting an output shaft 15 of motor 14. Also provided at the distal end portion of the extension 19 is a seal 18 to prevent the ingress of water past the bearings 16.

Secured to the end of output shaft 15 is a connector 21. Connector 21 might be formed as a plastics moulding and is designed to apply an outward retaining force on a selected cleaning utensil 20. As an alternative to solely providing an outward retaining force, the connector and the inner surface of the cleaning utensil might be provided with mating grooves like a splined shaft interconnection.

Attached either permanently or temporarily to the handle 11 is a shroud 17 that partly surrounds the utensil 20. The shroud is preferably transparent, but might alternatively be translucent or opaque. The shroud is typically made of plastics material. It might be glued, snap-engaged, integrally formed, or otherwise attached to the handle 11.

In use, a wet piece of fruit or vegetable or dry piece of fruit or vegetable can be cleaned or peeled with the device 10. To this end, the utensil can be caused to spin by activating switch 13. The utensil can then be pressed against the fruit or vegetable's surface with the shroud 17 located between the utensil 20 and the user's face so as to protect the user's eyes for example. If the shroud is transparent, the user will have good visual access to the fruit or vegetable and the utensil 20. Cleaning or peeling can be done over the kitchen sink, even with the device partially or fully immersed.

As can be seen, the utensil 20 has an end portion proximal to the handle that surrounds the projection 19. This in effect provides a tortuous path for water en route to the seal 18 and therefore aids in preventing the ingress of water past the bearings 16.

The batteries 12 could be non-rechargeable, but would typically be of a rechargeable type, in which case a recharging coil might be located in the base end of the handle. Such a coil could be placed in the magnetic field of a mains-powered benchtop recharging stand.

A number of different types of cleaning or peeling utensil are shown in FIGS. 2 to 10.

In FIG. 2 there is depicted a multi-purpose plastics utensil 20A having fine cleaning grooves on its surface.

The tip of the utensil 20A is in the form of a cross having fine serrations on the outer edges of the cross.

In FIG. 3, a utensil 20B having multi-purpose bristles is depicted.

In FIG. 4, a contoured hard-soft utensil 20C is shown. The contoured surface of this utensil enables the utensil to be used on relatively round fruit or vegetables. The utensil 20C has an auger-shaped tip.

In FIG. 5 there is depicted a utensil 20D that might be useful as a polisher, cleaner or rubber. This utensil has a cylindrical main surface with four radially projecting longitudinal, wavy strips.

In FIG. 6 there is depicted a utensil 20E, typically formed of plastics material and intended to make grooves in a piece of fruit or a vegetable. This utensil includes a number of bumps which make grooves upon rotation of the utensil.

In FIG. 7, there is depicted a rasp utensil 20F having rasping teeth on its cylindrical surface and an auger-shaped extension of the rasping teeth at the tip of the utensil.

In FIG. 8 a spiral scrubber utensil 20G which is typically made of plastics material is intended to help remove debris from a fruit or vegetable surface.

Finally, in FIGS. 9 and 10 there is depicted a heavy duty shredding utensil 20H that has a pair of diametrically opposed blades at the back of respective lengthwise quadrant-shaped cavities. These blades might be an integral part of a plastics moulded utensil or attached metal pieces.

In each of the utensils depicted in the drawings, the tip portions can be used by pointing the tip at the fruit or vegetable to remove “eyes”, stems, cores or other fruit or vegetable parts or hard-to-remove “attachments”.

It should be appreciated that modifications and alterations obvious to those skilled the art are not to be considered as beyond the scope of the present invention. For example, the batteries 12 might be of a non-rechargeable type, in which case the base end of the handle 11 might be provided with a removable cap.

1. A hand-held fruit and vegetable surface cleaner/remover comprising:
a housing including a handle,
a motor housed within the housing,
an output shaft extending from the motor, and
a cleaning or surface-removal utensil attached to the output shaft and surrounding a portion of the output shaft that is within the housing.

2. The cleaner of claim 1 wherein said portion of the output shaft is located within a projection of the housing.

3. The cleaner of claim 2 wherein the projection includes one or a pair of bearings supporting the output shaft.

4. The cleaner of claim 2 wherein an end portion of the projection is provided with a seal that engages with the output shaft.

5. The cleaner of claim 1 wherein there is mounted on the output shaft a connector onto which the utensil is mounted.

6. The cleaner of claim 1 wherein a shroud is attached to the handle and extends alongside the utensil.

7. The cleaner of claim 1 wherein the handle houses a battery or batteries.

8. The cleaner of claim 6 wherein the shroud is light-transmissive.

9. The cleaner of claim 6 wherein the shroud is transparent.

10. The cleaner of claim 7 wherein the battery or batteries are rechargeable by means external to the handle.

11. The cleaner of claim 1 wherein the utensil rotates with the output shaft.

12. The cleaner of claim 1 wherein the housing further comprises an integral projection that contains a portion of the output shaft.
